(19) United States
(12) Patent Application Publication
(10) Pub. No.: US 2009/0289916 A1
(43) Pub. Date: Nov. 26, 2009

(54) ELECTRONIC DEVICE AND METHOD FOR SWITCHING BETWEEN LOCKED STATE AND UNLOCKED STATE

(75) Inventor: LUNG DAI, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/471,342

(22) Filed: May 22, 2009

(30) Foreign Application Priority Data
May 23, 2008 (CN) 200810301762.X

(51) Int. Cl. G06F 3/041; G06F 3/033

(52) U.S. Cl. 345/173; 715/863

(57) ABSTRACT

A method for switching an electronic device with a touch sensitive display between a locked state and an unlocked state. The method includes receiving multiple contacts with respect to multiple predefined areas of the touch-sensitive display; detecting a sequence pattern in response to receiving the multiple contacts; determining if the recognized sequence pattern matches a predefined sequence pattern; and switching the electronic device to the unlocked state in response to determining that the recognized sequence pattern matches the predefined sequence pattern, so as to allow the electronic device to be manipulated in the unlocked state. An electronic device using the method is provided.

### BACKGROUND

1. Technical Field

The present disclosure relates to electronic devices, and more particularly to an electronic device and a method for switching between a locked state and an unlocked state.

2. Description of Related Art

Electronic devices, such as mobile phones generally employ touch sensitive displays as combined input/output devices. A touch sensitive display generally includes a display screen and a touch sensitive screen. The touch sensitive screen receives inputs/contacts from a user's finger or a stylus. In response to the inputs/contacts, the display screen may display a graphical user interface, allowing a set of functions to be performed.

However, the conventional electronic devices are disadvantageous in that the touch screens may be activated unintentionally or unknowingly, so that unintended functions may be performed or unauthorized users may have access to the device.

Therefore, it is desired to provide an electronic device and a method for overcoming the described shortcomings and deficiencies.

### BRIEF DESCRIPTION OF THE DRAWINGS

FIG. 1 is a block diagram of an electronic device capable of being switched between a locked state and an unlocked state in accordance with an exemplary embodiment.

FIG. 2 is a schematic diagram showing an input interface generated by the electronic device of FIG. 1 in accordance with a first exemplary embodiment.

FIG. 3 is a schematic diagram showing an input interface generated by the electronic device of FIG. 1 in accordance with a second exemplary embodiment.

FIG. 4 is a schematic diagram showing an input interface generated by the electronic device of FIG. 1 in accordance with a third exemplary embodiment.

FIG. 5 is a flowchart of a method for switching between a locked state and an unlocked state of the electronic device of FIG. 1 in accordance with an exemplary embodiment.

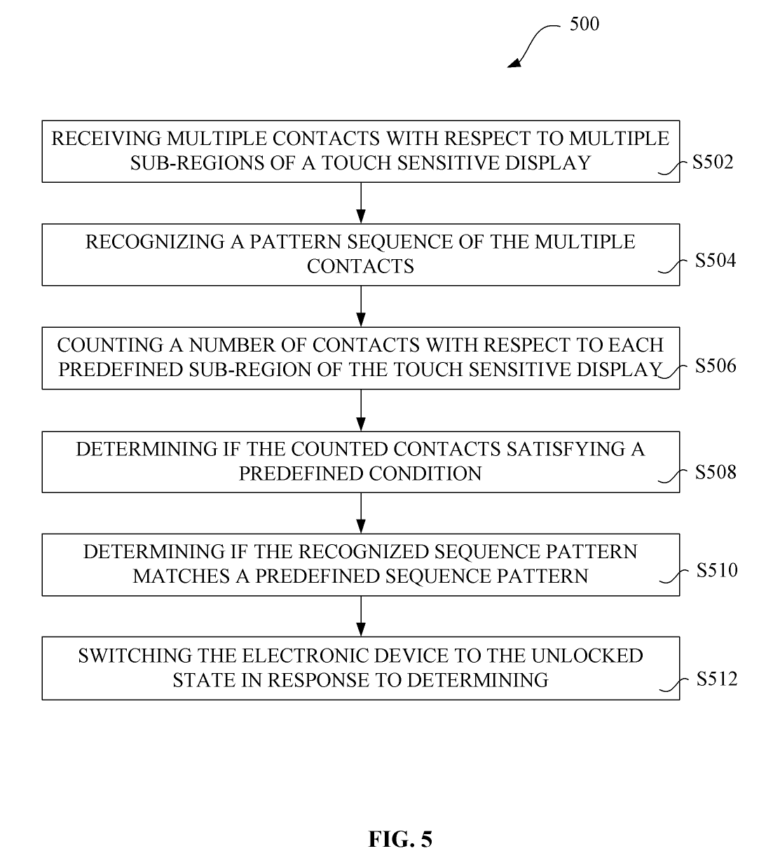

### DETAILED DESCRIPTION

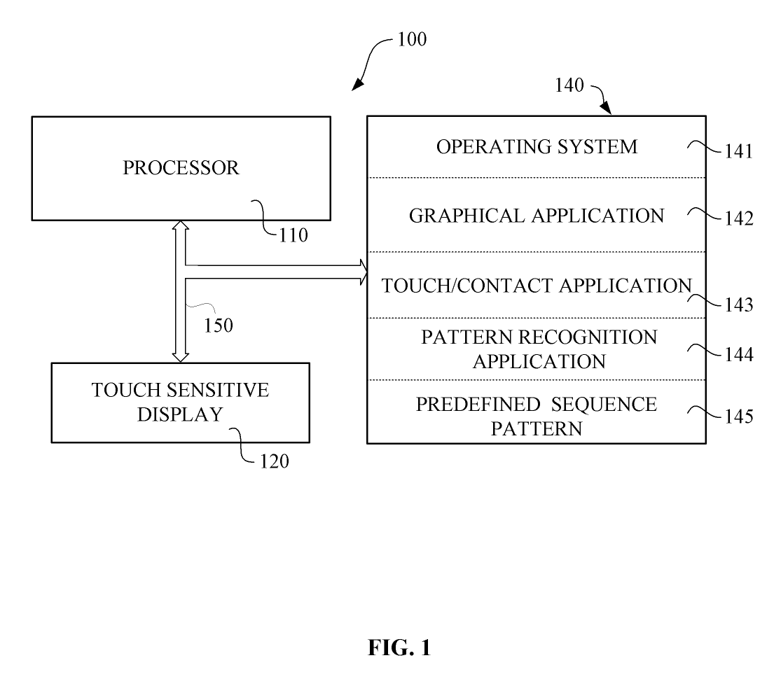

Referring to FIG. 1, a block diagram of an electronic device 100 in accordance with an exemplary embodiment is shown. The electronic device 100 generally includes a processor 110, a touch sensitive display 120, and a storage device 140, all interconnected by a bus 150.

The processor 110 executes/runs various software components stored in the storage device 140 to perform various functions for the electronic device 100, and controls the operations of the electronic device 100.

The touch sensitive display 120 provides both an output interface and an input interface between the electronic device 100 and a user. The touch sensitive display 120 is operable to receive inputs/contacts by one or more means, for example, a stylus and/or a user's finger. The touch sensitive display 120 may receive/detect the inputs/contacts using any of a plurality of touch sensitivity technologies, including but not limited to capacitive, resistive, infrared, and surface acoustic wave technologies. The touch sensitive display 120 is also operable to display visual outputs to the user. The visual outputs may include text, graphics, video, and any combination thereof. The touch sensitive display 120 may use liquid crystal display (LCD) technology, or light emitting polymer (LPD) display technology, although other display technologies may be used in other embodiments.

The storage device 140 includes one or more types of memory, such as read only memory (ROM) and random access memory (RAM). The storage device 140 may store an operating system 141, a graphical application 142, a touch/contact application 143, a pattern determining application 144, and a predefined sequence pattern 145.

The operating system 141 (e.g., LINUX®, UNIX®, WINDOWS®, or an embedded operating system such as VxWorks®) includes various procedures, sets of instructions, software components and/or drivers for controlling and managing general system tasks (e.g., memory management, storage device control, and power management, etc.) and facilitating communication between various hardware and software components.

The graphical application 142 includes various software components and/or set of instructions, which may be implemented by the processor 110 for rendering and displaying graphical user interfaces (GUI) on a display surface of the touch sensitive display 120. It should be noted the GUI may include any object that can be displayed, including, text, web pages, icons (such as user interface objects including soft keys), digital images, videos, animations and the like.

The touch/contact application 143 includes various software components and/or set of instructions, which may be invoked/implemented by the processor 110 for detecting inputs/contacts with the touch sensitive display 120. More particularly, the touch/contact application 143 may be invoked/implemented for performing various operations related to detection of inputs/contacts with the touch sensitive display 120, such as determining if the inputs/contacts has occurred, and determining if the inputs/contacts has ended (i.e., if the inputs/contacts has ceased).

The pattern recognition application 144 includes various software components and/or set of instructions, which may be invoked/implemented by the processor 110 for recognizing a sequence pattern of the touch input/contacts with respect to the touch sensitive display 120. More detail with respect to recognition of the sequence pattern will be described hereinafter.

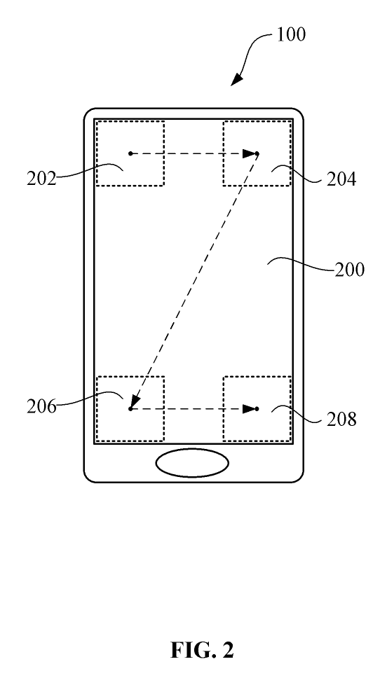

Also referring to FIG. 2, in operation, the processor 110 of the electronic device 100 invokes/implements the graphical application 142 to display a GUI 200 by the touch sensitive display 120. In a first exemplary embodiment, the GUI 200 defines a first area 202, a second area 204, a third area 206, and a fourth area 208 at four corners of the touch sensitive display 120 correspondingly. In FIG. 2, the first, second, third, and fourth areas 202, 204, 206, 208 are shown with four dashed rectangles. In practice, the first, second, third, fourth areas 202, 204, 206, 208 are hidden and invisible to the user.

When the electronic device 100 is to be switched from the locked state to the unlocked state, an unlock input procedure is performed on the first, second, third, and fourth areas 202, 204, 206, 208 correspondingly in a predetermined manner. The unlock input procedure is performed by first touching the first area 202 and sliding to the second area 204. Then, the unlock input procedure is performed by touching the second area 204 and sliding to the third area 206. Further, the unlock input procedure is performed by touching the third area 206 and sliding to the fourth area 208. After that, the fourth area 208 is touched. In this case, the first, second, third, and fourth areas 202, 204, 206, 208 are touched in a sequential order. Thus, in the first exemplary embodiment, the unlock input procedure forms a “Z” shaped sequence pattern (see FIG. 2) on the GUI 200. The processor 110 of the electronic device 100 invokes/implements the touch/contact application 143 to detect whether the inputs/contacts in the unlock input procedure occurred in the first, second, third, and fourth areas 202, 204, 206, 208. The processor 110 further invokes/implements the pattern recognition application 144 to recognize the sequence pattern created by the unlock input procedure. Because the electronic device 100 is preset with a predefined sequence pattern, the processor 110 determines if the recognized sequence pattern matches the predefined sequence pattern. If the recognized sequence pattern matches the predefined sequence pattern, the electronic device 100 is unlocked, so as to grant access to the electronic device 100.

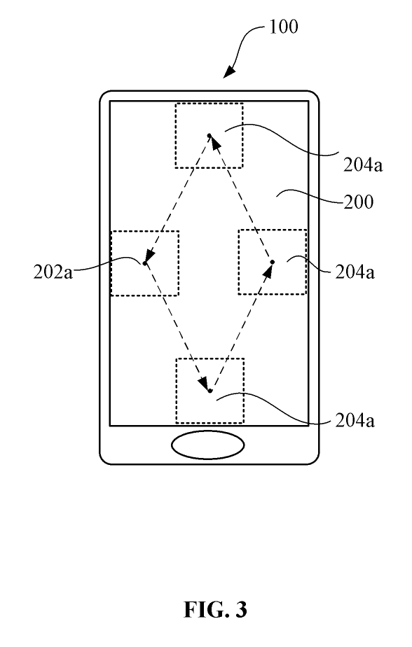

Referring to FIG. 3, in a second exemplary embodiment, the GUI 200 defines a first area 202a, a second area 204a, a third area 206a, and a fourth area 208a. The first, second, third, fourth areas 202a, 204a, 206a, 208a are located at the center of four sides of the touch sensitive display 120. The first, second, third, fourth areas 202a, 204a, 206a, 208a receives inputs/contacts in a diamond shaped sequence pattern (see FIG. 3) to unlock the electronic device 100.

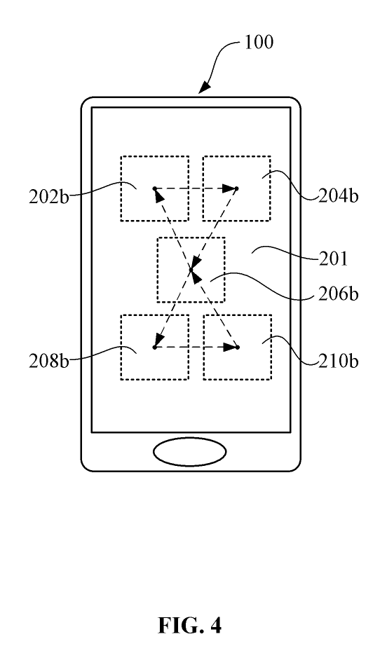

Referring to FIG. 4, in a third exemplary embodiment, the GUI 200 defines a first area 202b, a second area 204b, a third area 206b, a fourth area 208a, and a fifth area 210b. The first, second, third, fourth, fifth areas 202b, 204b, 206b, 208b, 210b receive inputs/contacts in two triangle shaped sequence pattern to unlock the electronic device 100.

Referring to FIG. 4, a flowchart illustrating a method 300 for switching between a locked state and an unlocked state of the electronic device 100 is shown. The method 300 includes the following blocks, each of which is tied to various modules contained in the electronic device 100 as shown in FIG. 1.

At block S502, the touch sensitive display 120 receives multiple inputs/contacts with respect to multiple areas defined in a GUI 200 of the touch sensitive display 120.

At block S504, the processor 110 of the electronic device 100 invokes/implements the touch/contact application 143 to recognize the multiple inputs/contacts, and the pattern recognition application 143 to recognize the sequence pattern of the touch input/contacts with respect to the multiple areas.

At block S506, the processor 110 counts a number of inputs/contacts with respect to each area defined in the GUI 200 of the touch sensitive display 120.

At block S508, the processor 110 determines if the counted number of inputs/contacts satisfies a predefined condition.

At block S510, the processor 110 further determines if the recognized sequence pattern matches a predefined sequence pattern, upon determination that the counted number of inputs/contacts satisfies the predefined condition.

At block S512, the processor 110 switches the electronic device 100 to the unlocked state in response to the determination that the recognized sequence pattern matches the predefined sequence pattern.

As described above, the electronic device 100 can be switched from the locked state to the unlocked state if inputs/contacts are input to the touch sensitive display 120 in a predefined sequence patter, thereby the electronic device can be prevented from activated being activated unintentionally.

It should be noted that the various blocks in the method 300 illustrated in FIG. 3 may be performed in the order presented, or may be performed in a different order. Furthermore, in some embodiments, some blocks can be canceled from the method 300.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the invention.

What is claimed is:

1. An electronic device capable of being switched between a locked state and an unlocked state, the electronic device comprising:
a touch sensitive display;
a memory;
a processor; and
a plurality of modules stored in the memory and configured for execution by the processor, the plurality of modules comprising instructions:
to receive multiple contacts with respect to multiple predefined areas of the touch sensitive display;
to recognize a sequence pattern of the multiple contacts in response to receiving the multiple contacts with respect to the multiple areas of the touch sensitive display;
to determine if the recognized sequence pattern matches a predefined sequence pattern stored in the memory; and
to switch the electronic device to the unlocked state in response to determining that the recognized sequence pattern matches the predefined sequence pattern, so as to allow the electronic device to be manipulated in the unlocked state.

2. The electronic device according to claim 1, wherein the multiple predefined areas are invisible to users.

3. The electronic device according to claim 1, wherein the multiple contacts with respect to the multiple areas are separate from each other.

4. The electronic device according to claim 1, wherein the one or more modules further comprises instructions to keep the electronic device in the locked state in response to determining that the recognized sequence pattern does not match the predefined sequence pattern, so as to prevent the electronic device from being manipulated in the locked state.

5. The electronic device according to claim 1, wherein the one or more modules further comprises instructions:
to count a number of contacts with respect to each predefined area of the touch sensitive display;
to determine if the counted number of contacts satisfying a predefined condition; and
to switch the electronic device to the unlocked state in response to determining that the recognized sequence pattern matches the predefined sequence pattern and the counted number satisfies the predefined condition, so as to allow the electronic device to be manipulated in the unlocked state.

6. The electronic device according to claim 1, wherein the one or more modules further comprises instructions:
to keep the electronic device in the locked state in response to determining that the counted number does not satisfy the predefined condition, so as to prevent the electronic device from being manipulated in the locked state.

7. A method for switching an electronic device with a touch sensitive display between a locked state and an unlocked state, the method comprising:
receiving multiple contacts with respect to multiple predefined areas of the touch-sensitive display;
recognizing a sequence pattern of the multiple contacts in response to receiving the multiple contacts with respect to the multiple predefined areas of the touch-sensitive display;
determining if the recognized sequence pattern matches a predefined sequence pattern stored in the memory; and
switching the electronic device to the unlocked state in response to determining that the recognized sequence pattern matches the predefined sequence pattern, so as to allow the electronic device to be manipulated in the unlocked state.

8. The method according to claim 7, wherein the multiple predefined areas are invisible to users.

9. The method according to claim 7, wherein the multiple contacts with respect to the multiple areas are separate from each other.

10. The method according to claim 7, further comprising:
switching the electronic device to the locked state in response to determining that the recognized sequence pattern does not match the predefined sequence pattern, so as to prevent the electronic device from being manipulated in the locked state.

11. The method according to claim 7, further comprising:
counting a number of contacts with respect to each predefined area of the touch sensitive display;
determining if the counted number of contacts satisfying a predefined condition; and
switching the electronic device to the unlocked state in response to determining that the recognized sequence pattern matches the predefined sequence pattern and the counted number satisfies the predefined condition, so as to allow the electronic device to be manipulated in the unlocked state.

12. The method according to claim 11, further comprising:
keeping the electronic device in the locked state in response to determining that the counted number does not satisfy the predefined condition, so as to prevent the electronic device from being manipulated in the locked state.

13. A method for controlling an electronic device with a touch sensitive display and a memory, the method comprising:
receiving multiple contacts with respect to multiple predefined areas of the touch-sensitive display;
recognizing a sequence pattern formed by the multiple contacts with respect to multiple areas;
counting a number of contacts with respect to each predefined area of the touch sensitive display;
determining if the counted number of contacts satisfying a predefined condition;
determining if the recognized sequence pattern matches a predefined sequence pattern stored in the memory; and
switching the electronic device to the unlocked state in response to determining that the recognized sequence pattern matches the predefined sequence pattern and the counted number of contacts satisfies the predefined condition, so as to allow the electronic device to be manipulated in the unlocked state.

14. The method according to claim 13, wherein the multiple predefined areas are invisible to users.

15. The method according to claim 13, wherein the multiple contacts with respect to the multiple areas are separate from each other.

16. The method according to claim 13, further comprising:
keeping the electronic device in the locked state in response to determining that the counted number does not satisfy the predefined condition, so as to prevent the electronic device from being manipulated in the locked state.
